(19) United States
(12) Patent Application Publication
(10) Pub. No.: US 2026/0330587 A1
(43) Pub. Date: Oct. 22, 2026

(54) ELECTRICITY-BASED CARBON CREDIT AGGREGATION AND CONVERSION SYSTEM AND METHOD FOR USING THE SAME

(71) Applicants: Chien Tung Hsu, Taipei (TW); Hua Yang Venture Capital CO.,LTD, Taipei (TW)

(72) Inventor: Chien Tung Hsu, Taipei (TW)

(21) Appl. No.: 19/437,098

(22) Filed: Dec. 30, 2025

(30) Foreign Application Priority Data
Apr. 17, 2025 (TW) 114114672

(51) Int. Cl. G06Q 50/43; B60L 53/62; B60L 53/64; G06Q 30/018; G06Q 50/06

(52) U.S. Cl. CPC G06Q 50/43; B60L 53/62; B60L 53/64; G06Q 30/018; G06Q 50/06

(57) ABSTRACT

An electricity-based carbon credit aggregation and conversion system and a method for using the same, are disclosed as follows. A rental management module and a vehicle management module perform rental and return operations of an electric vehicle. An electric energy management module calculates total energy consumption based on the driving distance, vehicle energy consumption rate, and charging condition of the electric vehicle. Subsequently, a smart analysis module derives an energy consumption pattern. Concurrently, a carbon credit calculation module determines the carbon emission amount based on the driving distance and total energy consumption of the electric vehicle, and converts this amount into at least one carbon emission credit. A carbon credit transaction module, based on a quantity and identity of the carbon emission credit, via a blockchain platform or a carbon credit trading platform, thereby contributing to the achievement of enterprise carbon neutrality goal.

### CROSS-REFERENCE TO RELATED APPLICATION

The present disclosure claims priority to Taiwan Patent Application No. 114114672, filed on Apr. 17, 2025, the disclosure of which is incorporated herein by reference in its entirety.

### BACKGROUND OF THE DISCLOSURE

### Field of the Disclosure

The present disclosure particularly relates to an electricity-based carbon credit aggregation and conversion system and a method for using the same, which use alternative energy as a power source for a rental transportation vehicle, rationally regulate allocation and use of electricity, and then perform carbon credit conversion and application according to consumed electricity.

### BRIEF DESCRIPTION OF RELATED ART

Traditional thermal power plants and nuclear power plants primarily rely on fossil fuels and nuclear energy to generate electricity. In the long term, this not only causes environmental pollution and resource depletion, but also exacerbates global warming. In response, various countries have made “alternative energy” a key focus for future development of green electricity and have actively promoted power generation technologies such as wind, hydro, geothermal, solar, and biomass energy to facilitate adoption of renewable energy. Among these, biomass energy uses organic matter as a source of energy, which can effectively make use of waste and convert the waste into a renewable form of energy. Additionally, the use of biomass energy can generate carbon credits, which are measured in units equivalent to one metric ton of carbon dioxide emissions. There are two main types of carbon credit applications. The first involves government regulatory measures that set a cap on a total carbon emission amount, and allocate emission allowances to enterprises according to industry categories. If an enterprise exceeds its allowance, the enterprise must engage in carbon trading to maintain carbon emission balance and achieve a goal of carbon emission reduction. The second type of carbon credits arises from a voluntary market, meaning that, in addition to national regulations, an enterprise or a related organization can voluntarily carry out an emission reduction project to obtain carbon credits. The carbon credits obtained through this mechanism are referred to as reduction credits, signifying that an emission reduction outcome has been certified and is eligible for trading in carbon market. Related patents for this technology are as follows:
(1) Taiwan Patent No. M641032U, titled “Power Storage and Carbon Right Trading System for Bicycle”.
(2) Chinese Patent Application Publication No. 118735681A, titled “Railway Enterprise Carbon Asset Management Method and System Based on Multi-Service System”; and
(3) U.S. Patent Application Publication No. US20230252382, titled “System and Method for Trading Emissions Units Using Vehicle Data”.

Although the aforementioned patents disclose technical features involving application of carbon credit trading to rental electric transportation vehicles, they do not disclose further integration of power plants and energy management for further virtualization and intelligent optimization, so that electricity and energy management can be optimized through Artificial Intelligence (AI), avoiding waste of surplus green electricity. Accordingly, there remains an unresolved problem as to how to combine distributed power sources with green energy-saving technologies and apply them to rental management of transportation vehicles, thereby generating carbon credits and further using the carbon credits for trading, to achieve energy saving and carbon emission reduction.

### SUMMARY OF THE DISCLOSURE

A main object of the present disclosure is to provide an electricity-based carbon credit aggregation and conversion system and a method for using the same, which apply distributed electric energy to rental of a transportation vehicle in an energy-saving manner, thereby enabling generation of at least one carbon credit, which can then be further used for trading to achieve both environmental and economic benefits.

The achieve the aforementioned object, the present disclosure utilizes a rental management module to handle the rental of electric vehicle, and a vehicle management module is used to perform dispatch and return of the electric vehicle, and a vehicle management module to manage their dispatch and return. An electric energy management module analyzes the driving distance, energy consumption rate, and charging conditions of the electric vehicle, and subsequently calculates the total energy consumption. A smart analysis module derives an energy consumption pattern of the electric vehicle to facilitate adjustment of a power supply mode. Furthermore, a plurality of green energy sources and renewable energy power grids can perform conversion to provide alternative energy. This alternative energy can be stored as electricity in an electric energy storage device and transmitted to a charging device for charging the electric vehicle. An electric power meter monitoring module measures current, voltage, and power, and the electric energy management module can adjust at least one charging parameter of the charging device using the current, the voltage, and the power. A carbon credit calculation module can calculate a carbon emission amount based on the driving distance and the total energy consumption of the electric vehicle, and convert the carbon emission amount into at least one carbon emission credit, and cause the at least one carbon emission credit to be stored in a carbon credit database. A carbon credit transaction module can then, based on a quantity and an identity of the at least one carbon emission credit stored in the carbon credit database, set a selling price on a blockchain platform or a carbon credit trading platform, generate a transaction contract, and perform electronic signing with a trading counterparty using the transaction contract. In summary, in the present disclosure, distributed energy sources such as green energy sources and renewable energy power grids are integrated. Based on the integration of distributed energy sources, carbon emissions are accurately calculated and converted into at least one carbon credit to enable practical implementation of carbon trading. Furthermore, by optimizing energy management, the achievement of enterprise carbon neutrality goal is facilitated, and development of electric transportation vehicles powered by green electricity is promoted, thereby advancing energy transition and enhancing societal value.

### BRIEF DESCRIPTION OF THE DRAWINGS

FIG. 1 is a system architecture diagram according to the present disclosure.

FIG. 2 is a flowchart (1) of a method according to the present disclosure.

FIG. 3 is a schematic diagram (1) of an implementation according to the present disclosure.

FIG. 4 is a schematic diagram (2) of an implementation according to the present disclosure.

FIG. 5 is a schematic diagram (3) of an implementation according to the present disclosure.

FIG. 6 is a flowchart (2) of a method according to the present disclosure.

### DETAILED DESCRIPTION OF PREFERRED EMBODIMENTS

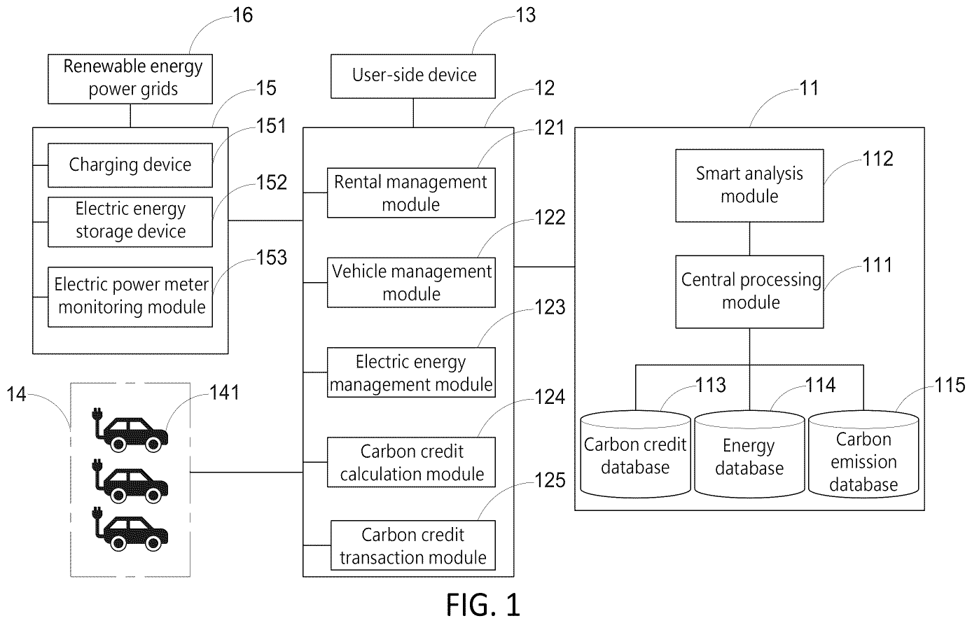

Referring to FIG. 1, in the present disclosure, an electricity-based carbon credit aggregation and conversion system 1 integrates and manages various types of distributed energy sources based on a concept of a virtual power plant. Energy data from electric transportation vehicles is collected, and corresponding carbon credits are generated and aggregated. These carbon credits can then be traded in a carbon trading market. The distributed energy sources include, for example, green energy sources or renewable energy power grids.

In the present disclosure, the electricity-based carbon credit aggregation and conversion system 1 mainly has a server 11. The server 11 is informationally and electrically connected to a transaction platform 12, a rental station 14, an energy storage cabinet 15, and a plurality of renewable energy power grids 16 or green energy sources. The server 11 is a cloud server based on a Software as a Service (SaaS) architecture. The transaction platform 12 can be operated by a user-side device 13 after connection. The user-side device 13 can include, for example, one of the following: a smartphone, a tablet, a personal computer, or a laptop. The rental station 14 is equipped with a plurality of electric vehicles 141. The transaction platform 12 can also be accessed through an operation interface at the rental station 14 to rent each of the electric vehicles 141. Each of the electric vehicles 141 can include, for example, one of the following: an electric bus, an electric car, an electric motorcycle, or a private electric vehicle. The energy storage cabinet 15 can be used to provide charging and power management for each of the electric vehicles 141. Each of the renewable energy power grids 16 or green energy sources can include, for example, one type of power generation facility such as solar power, wind power, hydropower, biomass power, or hybrid renewable power, which is connected to a power grid.

Referring to FIG. 1, the server 11 has a central processing module 111. The central processing module 111 is informationally connected to a smart analysis module 112, a carbon credit database 113, an energy database 114, and a carbon emission database 115. Components of the server 11 are described in further detail below:
(1) The central processing module 111 has computing and data processing capabilities and can include one of the following or a combination thereof: a Central Processing Unit (CPU), a Graphics Processing Unit (GPU), a Microprocessing Unit (MPU), or a Micro-Control Unit (MCU). But the present disclosure is not limited thereto. The central processing module 111 is configured to operate the modules of the electricity-based carbon credit aggregation and conversion system 1 and to perform data exchange and data integration among different devices.
(2) The smart analysis module 112 can, for example, include, but is not limited to, a Long Short-Term Memory (LSTM) based on deep learning. The smart analysis module 112 is configured to perform data optimization according to relevant data recorded in the carbon credit database 113 and the energy database 114. The data optimization can include, for example, predicting electricity demand, detecting abnormal energy consumption behavior, or deriving an energy consumption pattern according to a past electric energy consumption trend of each of the electric vehicles 141. Preferably, the smart analysis module 112 can further perform parameter optimization according to data content within a big data database.
(3) The carbon credit database 113 is configured to store carbon credit data. The energy database 114 is configured to store energy (e.g., green electricity) data, such as the amount of stored energy and the amount of consumed energy. The carbon emission database 115 is configured to store carbon emission data. Additionally, each of the databases, namely the aforementioned carbon credit database 113, energy database 114, and carbon emission database 115, can include one of the following or a combination thereof: a Solid-State Disk or Solid-State Drive (SSD), a Hard Disk Drive (HDD), a Static Random Access Memory (SRAM), a Dynamic Random Access Memory (DRAM), a relational database, or a non-relational database. Relevant data stored in each of the databases can further be used by the smart analysis module 112 for big data analysis and optimization.

The transaction platform 12 is informationally connected to the aforementioned rental station 14 and can be operated via a User Interface (UI). The transaction platform 12 has a rental management module 121, a vehicle management module 122, an electric energy management module 123, a carbon credit calculation module 124, and a carbon credit transaction module 125, which are informationally connected to each other. The details are as follows:
(1) The rental management module 121 is configured to handle a process of a rental transaction for each of the electric vehicles 141, such as rental start and end time calculation, rental fee calculation, contract generation, and transaction detail recording.
(2) The vehicle management module 122 is configured to perform analysis based on geographical locations of users to identify areas with higher demand for vehicle resources, thereby enabling reasonable resource dispatching for specific types of electric vehicles 141. Additionally, the vehicle management module 122 can monitor vehicle status in real time and detect whether each of the electric vehicles 141 is operating normally.
(3) The electric energy management module 123 is configured to monitor battery status and charging/discharging condition of each of the electric vehicles 141, and to calculate energy consumption and usage of each of the electric vehicles 141, so that optimized charging can be performed according to real-time electricity demand.
(4) The carbon credit calculation module 124 is configured to obtain energy consumption data of each of the electric vehicles 141 and then calculate a carbon emission amount according to total energy consumption. The carbon emission amount can be determined by converting electricity consumption into a corresponding carbon emission amount with reference to an international standard such as International Organization for Standardization (ISO) 14064 or a Greenhouse Gas (GHG) protocol.
(5) The carbon credit transaction module 125 is configured to perform matching for trading of carbon credits, price calculation, contract signing, and trade execution and settlement. A trading counterparty is determined through a supply-and-demand matching mechanism. A reasonable quotation is calculated according to a current carbon market price. A smart contract is signed using blockchain or digital signature technology to ensure transaction credibility and to complete carbon credit transfer and data updating.

The energy storage cabinet 15 is electrically connected to the renewable energy power grids 16. The energy storage cabinet 15 is configured with a charging device 151, an electric energy storage device 152, and an electric power meter monitoring module 153, which are electrically connected to each other. The charging device 151 is configured to input electric energy from the renewable energy power grids 16 or external power sources (such as the green energy sources) into the energy storage cabinet 15 and to charge the electric vehicles 141. The electric energy storage device 152 itself has a high-performance battery module, such as one of the following: a Lithium-ion (Li-ion) battery module, a Lithium Iron Phosphate (LiFePO₄) battery, or a solid-state battery module. The electric energy storage device 152 can store surplus electric energy and release electric energy during peak grid load periods to enhance electricity dispatch flexibility and reduce electricity cost. The electric power meter monitoring module 153 is configured to monitor, in real time, data such as current, voltage, power, and frequency during charging and discharging processes. The electric power meter monitoring module 153 can also record electricity usage behavior, and through a battery management system, perform power adjustment and optimize health and charging efficiency of the electric energy storage device 152. In conjunction with a bidirectional inverter, bidirectional electric energy conversion can be performed to provide large-scale energy storage and to realize effective energy flow and allocation. Furthermore, an energy management system built into the energy storage cabinet 15 can assist in “electricity trading services” having frequency regulation reserve, real-time reserve, and supplemental reserve functions, thereby fulfilling operational requirements of a large-scale energy storage system and objectives of electricity market dispatch.

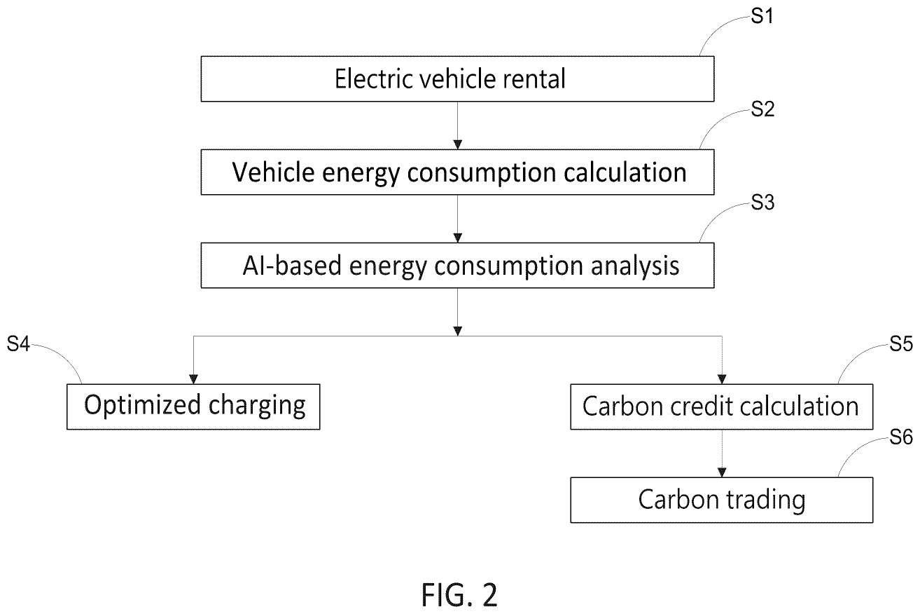

Referring to FIG. 2, in the present disclosure, the electricity-based carbon credit aggregation and conversion system 1 performs rental of a transportation vehicle, energy consumption calculation, charging, and carbon credit conversion and trading through the following operations:

An electric vehicle rental operation S1: When a user has a vehicle rental demand, a user-side device 13 is used to connect to a transaction platform 12 for operation, or alternatively, an operation interface at a rental station 14 is used directly to connect to the transaction platform 12 for operation. After user identity verification and electronic contract application and processing are completed, the system provides and evaluates vehicle status information of an electric vehicle 141, such as vehicle availability, battery level, and maintenance status. Subsequently, a rental management module 121 selects the electric vehicle 141 which is currently available for rental, and at the same time, begins recording rental time. Additionally, a vehicle management module 122 can be used to dispatch the selected electric vehicle 141 to a specific area, thereby completing a vehicle rental process. After the user returns the vehicle, a rental fee is settled.

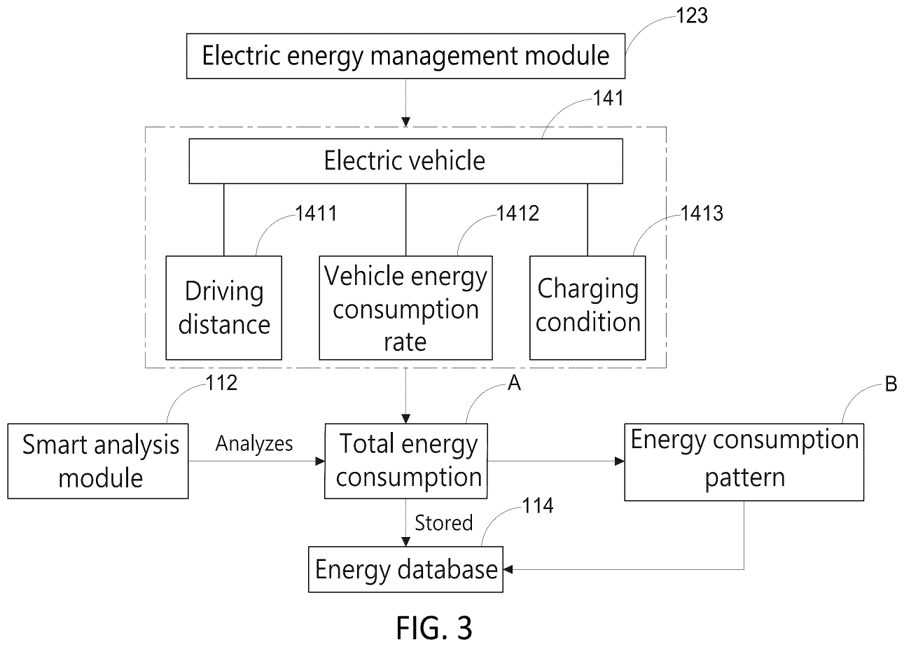

A vehicle energy consumption calculation operation S2: An electric energy management module 123 is used to calculate total energy consumption A of the electric vehicle 141. Referring to FIG. 3, the electric energy management module 123 analyzes a driving distance 1411, a vehicle energy consumption rate 1412, and charging condition 1413 of the electric vehicle 141 and then calculates the total energy consumption A. The driving distance 1411 can be used to estimate actual total driving distance (km) based on energy consumption per minute or hour. The vehicle energy consumption rate 1412 can be derived, for example, by calculating a ratio of electric energy consumed during a driving process of the vehicle to a driving distance, thereby reflecting actual energy consumption condition. The charging condition 1413 is calculated through monitoring a previous charging amount and charging time of the electric vehicle 141. Specifically, the electric energy management module 123 records difference in battery level at start and end of battery charging, and calculates a charging rate to reflect charging efficiency and required charging time of the electric vehicle 141. Combining the above, the electric energy management module 123 calculates electric energy consumption during the driving process according to parameters such as speed, a load, and road condition of the electric vehicle 141 during driving, and dynamically adjusts the vehicle energy consumption rate 1412. At the same time, battery loss during a charging process is included in calculation. Finally, the electric energy management module 123 obtains the total energy consumption A by summing driving energy consumption, charging energy consumption, and standby energy consumption of the electric vehicle 141.

An artificial intelligence (AI)-based energy consumption analysis operation S3: Based on the preceding operation, a smart analysis module 112 further derives an energy consumption pattern B of the electric vehicle 141 based on the total energy consumption A. Referring to FIG. 3, the smart analysis module 112 interprets energy consumption condition during charging and driving processes within the total energy consumption A, and derives, based on deep learning technology, the energy consumption pattern B of the electric vehicle 141. The energy consumption pattern B can include, for example, a prediction of at least one road segment with higher energy consumption when the electric vehicle 141 is driven on at least one urban road, according to factors such as traffic flow, driving speed, stop-and-go frequency, and road surface condition. Or, when the electric vehicle 141 is driven on at least one highway, a lower energy consumption can be predicted and determined according to stable speed and fewer stop-and-go events. In one embodiment, the smart analysis module 112 adjusts the energy consumption pattern B according to weather conditions (e.g., temperature or wind speed). For example, the smart analysis module 112 can predict additional energy consumption due to reduced battery efficiency in low-temperature weather, or predict increased energy consumption when the electric vehicle 141 is driven uphill. Based on the above, the total energy consumption A and the energy consumption pattern B are synchronously stored in the energy database 114 as big data, which can be continuously used by the smart analysis module 112 for optimization and parameter adjustment.

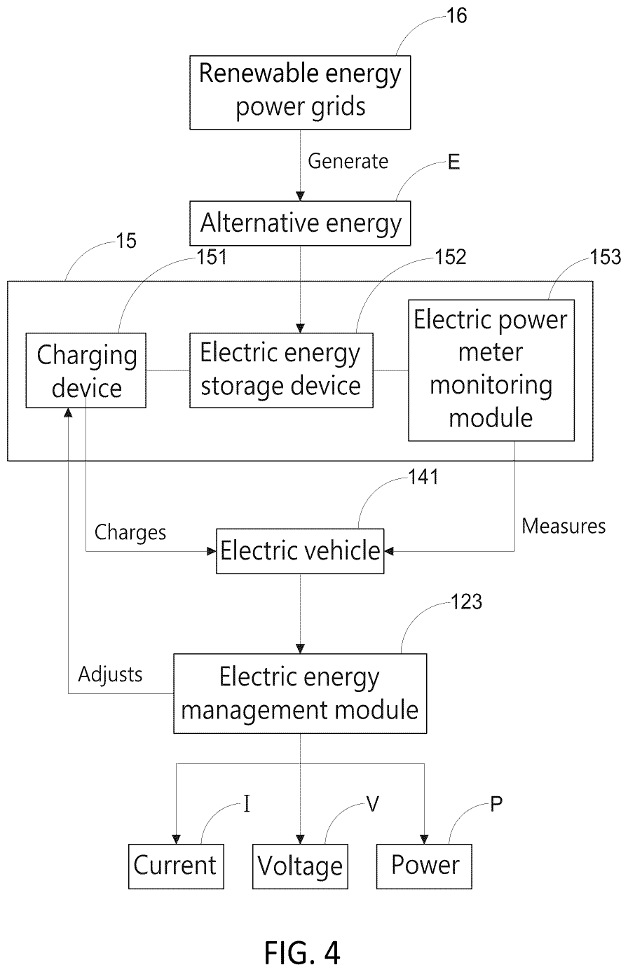

An optimized charging operation S4: Referring to FIG. 4, a plurality of renewable energy power grids 16 perform conversion to provide alternative energy E through a plurality of renewable energy facilities (such as solar energy, wind energy, and hydro energy) combined with power grids. The alternative energy E is stored as electricity in an electric energy storage device 152 (e.g., a lithium battery), and is then delivered to a charging device 151. The charging device 151, which can be a charging pile, performs optimized charging on the electric vehicle 141. During a process of the optimized charging, an electric power meter monitoring module 153 synchronously measures current I, voltage V, power P, or charging time. The electric energy management module 123 can record the current I, the voltage V, the power P, or the charging time, based on which the electric energy management module 123 adjusts at least one charging parameter of the charging device 151. This ensures the safety and efficiency of the process of the charging process, prevents overcharging or overheating, and enhances overall energy management.

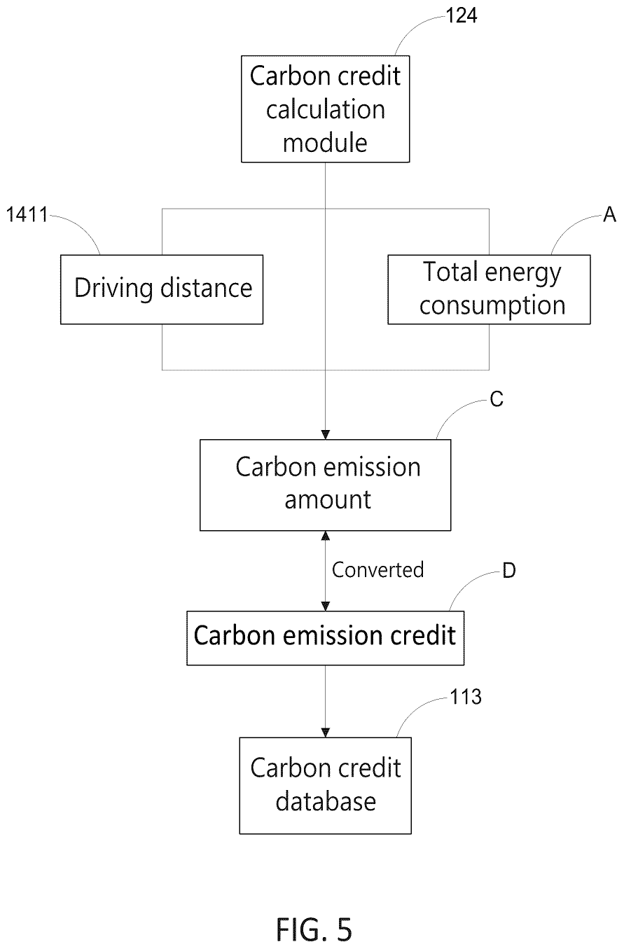

A carbon credit calculation operation S5: After completion of the AI-based energy consumption analysis operation S3, the present operation is performed concurrently. Referring to FIG. 5, a carbon credit calculation module 124 calculates energy consumption per kilometer driven (e.g., in kilowatt-hours (kWh)) based on the driving distance 1411 and the total energy consumption A of the electric vehicle 141. The carbon credit calculation module 124 then multiplies the energy consumption per kilometer by a corresponding greenhouse gas emission factor to calculate a carbon emission amount C generated during driving of the electric vehicle 141. The emission factor reflects the amount of greenhouse gas (e.g., carbon dioxide) emitted per unit of energy consumed and varies depending on a type of energy source used. For example, for renewable energy, the emission factor is lower, whereas for conventional energy (such as coal or natural gas), the emission factor is higher. Furthermore, the calculated carbon emission amount C, expressed in kilograms or metric tons, is converted into at least one carbon emission credit D according to at least one carbon market rule and stored in a carbon credit database 113. According to the at least one carbon market rule, an enterprise or an entity is subject to a government-specified emission allowance. If the carbon emission amount C exceeds the allowance, at least one additional carbon emission credit D must be purchased, whereas if the carbon emission amount C is below the allowance, at least one surplus carbon emission credit D can be sold.

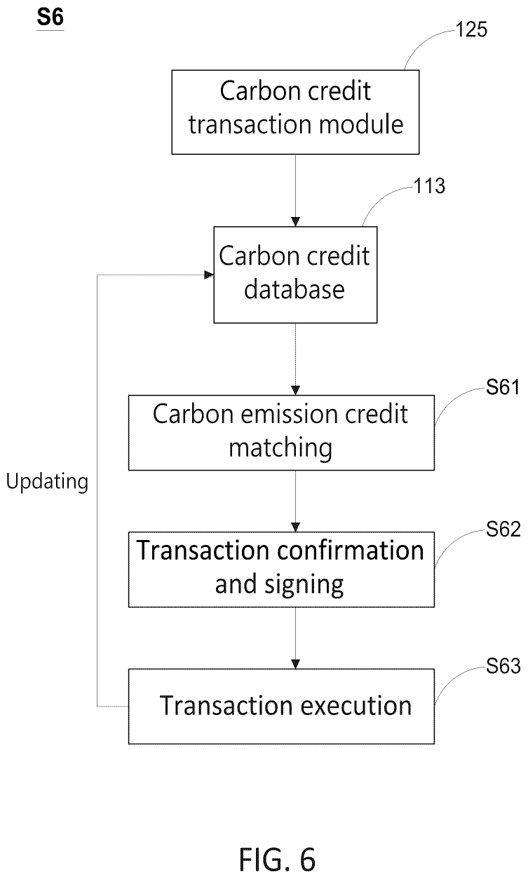

A carbon trading operation S6: A carbon credit transaction module 125 obtains the at least one carbon emission credit D from the carbon credit database 113. A user (an enterprise) conducts a transaction with another user (a trading counterparty) using the at least one carbon emission credit D. Referring to FIG. 6, the present operation includes the following sub-operations:
(1) A carbon emission credit matching operation S61: The carbon credit transaction module 125 transmits relevant information such as a quantity and an identity of the at least one carbon emission credit D stored in the carbon credit database 113 to an external blockchain platform or a carbon credit trading platform, sets a selling price for the at least one carbon emission credit D, and after the selling price is confirmed, performs matching with the trading counterparty.
(2) A transaction confirmation and signing operation S62: Based on the preceding operation, after matching is completed on the platform, the carbon credit transaction module 125 generates, based on the identity of the at least one carbon emission credit D, a transaction contract for electronic signing by the trading counterparty.
(3) A transaction execution operation S63: Upon completion of the electronic signing, the identity of the at least one carbon emission credit D is transferred to the trading counterparty.

As described above, in the present disclosure, an electricity-based carbon credit aggregation and conversion system and a method for using the same primarily involve the following: First, a rental management module and a vehicle management module manage rental and return of an electric vehicle. Subsequently, an electric energy management module analyzes driving distance, a vehicle energy consumption rate, and charging condition of the rented and then returned electric vehicle, and then calculates total energy consumption. A smart analysis module derives an energy consumption pattern of the electric vehicle using the total energy consumption. Furthermore, in the present disclosure, a plurality of renewable energy power grids (or green energy sources) perform conversion to provide alternative energy, which is then stored in an electric energy storage device. A charging device, using the alternative energy stored in the electric energy storage device, can perform optimized charging on the electric vehicle. An electric power meter monitoring module measures current, voltage, and power, and the electric energy management module adjusts at least one charging parameter of the charging device using the current, the voltage, and the power. In this way, a carbon credit calculation module can calculate a carbon emission amount based on the driving distance and the total energy consumption of the electric vehicle, and convert the calculated carbon emission amount into at least one carbon emission credit. The at least one carbon emission credit can be further traded on a blockchain platform or a carbon credit trading platform through execution of a carbon credit transaction module.

In summary, the present disclosure, upon implementation, can indeed achieve an object of providing an electricity-based carbon credit aggregation and conversion system and a method for using the same, which apply distributed electric energy to rental of a transportation vehicle in an energy-saving manner, thereby enabling generation of at least one carbon credit, which can then be further used for trading to achieve both environmental and economic benefits.

The above is only the preferred embodiments of the present disclosure, and is not intended to limit the present disclosure to the forms disclosed. Any modifications, equivalent alternatives, and improvements made within the spirit and the scope of present disclosure by people skilled in the art should be included in the scope of claims of the present disclosure.

### REFERENCE NUMERALS IN DRAWINGS

1 an electricity-based carbon credit aggregation and conversion system
11 a server
111 a central processing module
112 a smart analysis module
113 a carbon credit database
114 an energy database
115 a carbon emission database
12 a transaction platform
121 a rental management module
122 a vehicle management module
123 an electric energy management module
124 a carbon credit calculation module
125 a carbon credit transaction module
13 a user-side device
14 a rental station
141 an electric vehicle
1411 a driving distance
1412 a vehicle energy consumption rate
1413 charging condition
15 an energy storage cabinet
151 a charging device
152 an electric energy storage device
153 an electric power meter monitoring module
16 renewable energy power grids
A total energy consumption
B an energy consumption pattern
C a carbon emission amount
D at least one carbon emission credit
E alternative energy
I current
V voltage
P power
S1 an electric vehicle rental operation
S2 a vehicle energy consumption calculation operation
S3 an AI-based energy consumption analysis operation
S4 an optimized charging operation
S5 a carbon credit calculation operation
S6 a carbon trading operation
S61 a carbon emission credit matching operation
S62 a transaction confirmation and signing operation
S63 a transaction execution operation

What is claimed is:

1. An electricity-based carbon credit aggregation and conversion system, comprising:
a server having a central processing module, the central processing module being informationally connected to a smart analysis module, a carbon credit database, and an energy database, wherein the carbon credit database stores a plurality of carbon emission credits.
a transaction platform being informationally connected to the server and a rental station, the rental station being equipped with a plurality of electric vehicles, and the transaction platform having an electric energy management module, a carbon credit calculation module, and a carbon credit transaction module.
the electric energy management module calculating total energy consumption of each of the electric vehicles based on a driving distance, a vehicle energy consumption rate, and charging condition of each of the electric vehicles.
the carbon credit calculation module calculating a carbon emission amount based on the driving distance and the total energy consumption, and converting the carbon emission amount into at least one of the carbon emissions credits.
the carbon credit transaction module, based on an identity of each of the carbon emission credits, performing matching with a trading counterparty, generating a transaction contract, and subsequently performing electronic signing, so as to transfer the identity of each of the carbon emission credits to the trading counterparty.
an energy storage cabinet being informationally connected to the server, electrically connected to a plurality of renewable energy power grids, and configured with a charging device, an electric energy storage device, and an electric power meter monitoring module that are electrically connected to each other.

2. The electricity-based carbon credit aggregation and conversion system of claim 1, wherein the smart analysis module derives an energy consumption pattern based on the total energy consumption and performs data optimization based on data from the carbon credit database and the energy database.

3. The electricity-based carbon credit aggregation and conversion system of claim 1, wherein the renewable energy power grids are configured to perform conversion to provide alternative energy, and to transmit the alternative energy to the electric energy storage device, and the charging device, using the alternative energy transmitted to the electric energy storage device, performs optimized charging on each of the electric vehicles.

4. The electricity-based carbon credit aggregation and conversion system of claim 3, wherein, during a process of the optimized charging, the electric power meter monitoring module measures voltage, current, and power, and the electric energy management module adjusts at least one charging parameter of the charging device based on the voltage, the current, and the power.

5. The electricity-based carbon credit aggregation and conversion system of claim 1, wherein the server has a rental management module informationally connected to the central processing module, the rental management module being configured to perform rental start and end time calculation, rental fee calculation, contract generation, and transaction detail recording.

6. A method for using an electricity-based carbon credit aggregation and conversion system, the method comprising:
an electric vehicle rental operation for connecting, using a user-side device, to a transaction platform and after a rental management module is executed, renting, using the user-side device, an electric vehicle.
a vehicle energy consumption calculation operation for analyzing, by an electric energy management module, a driving distance, a vehicle energy consumption rate, and charging condition of the electric vehicle, and calculating, by the electric energy management module, total energy consumption.
an artificial intelligence (AI)-based energy consumption analysis operation for deriving, by a smart analysis module, an energy consumption pattern of the electric vehicle based on the total energy consumption, and performing, by the smart analysis module, data optimization based on data from a carbon credit database and an energy database;
a carbon credit calculation operation for calculating, by a carbon credit calculation module, a carbon emission amount based on the driving distance and the total energy consumption of the electric vehicle, converting, by the carbon credit calculation module, the carbon emission amount into at least one carbon emission credit according to at least one carbon market rule, and causing, by the carbon credit calculation module, the at least one carbon emission credit to be stored in the carbon credit database;
a carbon trading operation for, after the at least one carbon emission credit is obtained from the carbon credit database by a carbon credit transaction module, performing a carbon emission credit matching operation, wherein the carbon credit transaction module, based on a quantity and an identity of the at least one carbon emission credit, performs matching with a trading counterparty on a blockchain platform or a carbon credit trading platform;
performing a transaction confirmation and signing operation, wherein the carbon credit transaction module, generates, based on the identity of the at least one carbon emission credit, a transaction contract for electronic signing by the trading counterparty; and
then performing a transaction execution operation, wherein, upon completion of the electronic signing, the identity of the at least one carbon emission credit is transferred to the trading counterparty.

7. The method for using the electricity-based carbon credit aggregation and conversion system of claim 6, wherein, in the vehicle energy consumption calculation operation, the electric energy management module calculates electric energy consumption according to speed, a load, and road condition of the electric vehicle during driving, dynamically adjusts the vehicle energy consumption rate, and obtains the total energy consumption by summing driving energy consumption, charging energy consumption, and standby energy consumption of the electric vehicle.

8. The method for using the electricity-based carbon credit aggregation and conversion system of claim 6, wherein, in the AI-based energy consumption analysis operation, the smart analysis module adjusts the energy consumption pattern based on weather conditions.

9. The method for using the electricity-based carbon credit aggregation and conversion system of claim 6, wherein, after completion of the AI-based energy consumption analysis operation, an optimized charging operation is subsequently performed, wherein a plurality of renewable energy power grids performs conversion to provide alternative energy and causes the alternative energy to be stored in an electric energy storage device, and a charging device, using the alternative energy stored in the electric energy storage device, performs optimized charging on the electric vehicle.

10. The method for using the electricity-based carbon credit aggregation and conversion system of claim 9, wherein, in the optimized charging operation, during a process of the optimized charging, the electric power meter monitoring module measures voltage, current, and power, and the electric energy management module adjusts at least one charging parameter of the charging device based on the voltage, the current, and the power.
